(19) United States
(12) Patent Application Publication
(10) Pub. No.: US 2013/0299388 A1
(43) Pub. Date: Nov. 14, 2013

(54) METHOD OF PREPARING A HYDROCONVERSION CATALYST BASED ON SILICA OR SILICA-ALUMINA HAVING AN INTERCONNECTED MESOPOROUS TEXTURE

(71) Applicants: Metin Bulut, Heusden-Zolder (BE); Régine Kenmogne-Gatchuissi, Calgary (CA); François Fajula, Teyran (FR); Jean-Pierre Dath, Beloeil Hainaut (BE); Sander Van Donk, Sainte-Adresse (FR); Annie Finiels, Montpellier (FR); Vasile Hulea, Montpellier (FR)

(72) Inventors: Metin Bulut, Heusden-Zolder (BE); Régine Kenmogne-Gatchuissi, Calgary (CA); François Fajula, Teyran (FR); Jean-Pierre Dath, Beloeil Hainaut (BE); Sander Van Donk, Sainte-Adresse (FR); Annie Finiels, Montpellier (FR); Vasile Hulea, Montpellier (FR)

(73) Assignees: CENTRE NATIONAL DE LA RECHERCHE SCIENTIFIQUE, Paris (FR); TOTAL RAFFINAGE MARKETING, Puteaux (FR)

(21) Appl. No.: 13/879,747

(22) PCT Filed: Dec. 23, 2011
(86) PCT No.: PCT/EP11/74027

§ 371 Date: Jul. 29, 2013

(30) Foreign Application Priority Data
Dec. 23, 2010 (FR) 10 61155

(51) Int. Cl. B01J 29/74; C10G 49/08; C10G 47/16

(52) U.S. Cl. CPC B01J 29/74; C10G 47/16; C10G 49/08
USPC 208/111.3; 208/111.35; 208/136; 208/137; 502/74

(57) ABSTRACT

The invention relates to a method for preparing a hydroconversion catalyst based on mesoporous silica or silica-alumina, comprising the following steps:
(A) deposition of alumina on a mesoporous material having interconnected pores by treatment with at least one aluminium-based reactant, so as to obtain a compound having a Si/Al ratio of between 0.1 and 1000;
(B) addition of at least one catalytically active species chosen from the group formed by the metals of group VIII and/or of group VIB; and
(C) drying followed by thermal and/or chemical treatment according to the invention.

The invention also relates to the catalyst thus obtained as well as a method of hydroconverting (hydrocracking, hydroisomerizing) a hydrocarbon feedstock, which comprises bringing the feedstock to be treated into contact with the hydroconversion catalyst according to the invention.

The invention relates to a method for preparing a hydroconversion catalyst based on silica or silica-alumina having an interconnected mesoporous texture.

The hydroconversion of heavy petroleum fractions represents an important challenge because of the reduction in oil reserves, because of ever stricter environmental standards on the composition of fuels (low content of sulphur and aromatics) and a strong market demand for middle distillates due to the increase in the number of diesel vehicles in the European automobile stock.

In such a context, a key factor in improving the selectivity of products for hydrocracking heavy feedstocks which are in excess and of low profitability to form high-value-added profitable derivatives (middle distillates of very high quality) is the formulation of more highly performing catalysts.

The catalysts commonly used in hydroconversion processes are bifunctional catalysts that combine a metalllic (Pt, Pd) phase or non-noble metals Ni/Mo, Ni/Co, Co/Mo, or Ni/W, with an acid phase provided by the support. Among acid supports are, in increasing order of acidity, aluminas, halogenated aluminas, amorphous silica-aluminas, and zeolites. Among these supports, Y(FAU) zeolites are widely used for preparing hydroconversion catalysts. However, these have drawbacks due to the presence of micropores that are inaccessible to large molecules. This is why such solids must undergo post-synthesis treatments such as dealumination, desilication and recristallization.

Another challenge in formulating the catalysts is therefore how to develop appropriate catalyst supports for which the diffusional constraints are the slightest.

Among solids that can be used, mesoporous silicas have a high specific surface area (1000 m²/g) and a mesoporous structure with pores of uniform size, which would overcome the steric constraints relating to the diffusion of large molecules.

Mesoporous silicas of ordered structure are obtained by synthesis starting from a silica precursor in the presence of structuring agents, which are micelles of surfactants. An amorphous silica is obtained that has a porous structure that is ordered on the scale of a few nanometres.

According to the International Union of Pure and Applied Chemistry (IUPAC), a material is termed microporous if the pore diameter (Dₚ) is less than 2 nm, termed mesoporous if Dₚ is between 2 nm and 50 nm and termed macroporous if Dₚ is greater than 50 nm.

Currently, various structured mesoporous silicas exist, produced via various surfactant/silica-precursor crosses.

Among interconnected mesostructured porous materials, the following may be distinguished:
mesoporous silicas of the M41 S family, which comprise materials of the MCM-41 type having a hexagonal 2D crystallographic structure (p6 mm space group), materials of the MCM-48 type, possessing a cubic (la3d) structure and materials of the MCM-50 type having a lamellar structure;
mesoporous silicas of SBA (Santa Barbara Amorphous) type. Among materials of this type, the following may be distinguished: SBA-1 (cubic), SBA-15 (hexagonal), SBA-16 (cubic), SBA-14 (lamellar) and SBA-12 (hexagonal);
mesoporous silicas of MCF (Mesostructured Cellular Foam) type, which are obtained by adding, in the synthesis of SBA-15 silicas, swelling agents such as TMB (1,3,5-trimethylbenzene) which causes the micelles to expand, thereby enabling a structure consisting of large uniform pores to be obtained. These materials have a high thermal stability; and
mesoporous silicas of MSU (Michigan State University) type, which are obtained from nonionic surfactants or from triblock copolymers.

All these solids with interconnected pores, because of their three-dimensional mesoporous network, facilitate the diffusion of molecules, thus avoiding the readsorption of the primary products of reaction and implicitly the secondary transformations (for instance overcracking). Consequently, the hydroisomerization and hydrocracking selectivities are improved.

As mesoporous silica matrices are not acids, it is necessary to acidify them for use in hydrocracking. The acidity may be provided either by inserting dispersed aluminium into the silica network by direct synthesis [C. T. Kresge, M. E. Leonowicz, W. J. Roth, J. C. Vartuli, J. S. Beck, Nature 1992, 359, 710 ; A. Corma, V. Fornes, M. T. Navarro, J. Perez-Pariente, Journal of Catalysis 1994, 148, 569], or by post-synthesis grafting with reactants such as AlCl₃ [R. Mokaya, Journal of Catalysis 2000, 193, 103], Al(NO₃)₃ [S. C. Shen and S. Kawi, Chemistry Letters 1999, 28, 1293], Al(O-i-Pr)₃ [R. Mokaya and W. Jones, Chemical Communications 1997, 2185].

The presence of aluminium confers Brönsted acid or Lewis acid sites on solids. Several studies have characterized the acidity by NH₃ TPD or by pyridine adsorption followed by infrared (FTIR) analysis [A. Jentys, N. H. Pham, H. Vinek, Journal of the Chemical Society, Faraday Transaction 1996, 62, 3287]; these studies show an increase in the density of acid sites with a reduction in the Si/Al ratio and an acid strength lower than that of zeolites.

Another study shows that, by incorporating aluminium directly into the gel for synthesizing MCM-41 silicas, the presence of aluminium deeply anchored into the structure may lead to a reduction in the structural order and also to a decrease in the hydrothermal stability [L. Y. Chen, Z. Ping, G. K. Chuah, S. Jaenicke, G. Simon, Microporous and Mesoporous Materials 1999, 27, 231].

Other studies mention the low activity of the catalysts obtained by direct aluminium incorporation into the synthesis gel, particularly with regard to n-C₁₆ hydrocracking reactions [K. C. Park, S. K. Ihm, Applied Catalysis A 2000, 203, 201; L. Perrotin, doctorate thesis, University of Montpellier II, 2001].

The objective of the present invention is to prepare a hydroconversion catalyst, especially for hydroconverting Fischer-Tropsch waxes and heavy feedstocks, which is based on a mesoporous material of high acidity and possessing a three-dimensional network of interconnected pores with a uniform size distribution, especially based on mesoporous silica of cubic structure (MCM-48 type for example).

The Applicant has discovered a novel method for preparing a hydroconversion catalyst based on mesostructured silica or silica-alumina with an interconnected porous texture, which is subsequently alumina-treated, having both good activity and good selectivity. Optionally, this alumina-treated material will be subsequently (or even simultaneously) chlorinated for the purpose of making the material even more acidic.

The catalyst obtained makes it possible in particular to improve the selectivity in terms of middle distillates (hydrocarbons containing 10 to 20 carbon atoms and distilling within the temperature range from 145° C. to 350° C.) of hydroconversion, particularly hydrocracking, reactions.

For this purpose, a first subject of the invention is a method for preparing a hydroconversion catalyst based on mesoporous silica or silica-alumina, comprising the following steps:

(A) deposition of alumina on a mesoporous material having interconnected pores by treatment with at least one aluminium-based reactant, for example chosen from AlCl₃, NaAlO₄, Al(NO₃)₃, Al(OR)₃ where R is chosen from linear or branched C₁-C₆ alkyl groups, so as to obtain a compound having a Si/Al ratio of between 0.1 and 1000;

(B) addition of at least one catalytically active species chosen from the group formed by the metals of group VIII and/or of group VIB; and

(C) drying followed by thermal and/or chemical treatment, such as reduction, and sulphurization.

Optionally, step (B) may further include the addition of one or more dopant metals chosen from the group of rare earths or from group IVB or IB and/or the addition of one or more other dopant elements for example chosen from chlorine, fluorine, boron and phosphorus. In particular, the addition of chlorine may allow the acidity of the material to be increased.

Preferably, the preferred metals of groups IVB and IB are Ti and/or Cu.

Generally, the steps of the above method are carried out in the following order: (A), (B), (C). However, it is conceivable for steps (A) and (B) to be carried out simultaneously or even for step (B) to be carried out before step (A).

Step (A): Deposition of Alumina on a Mesoporous Material having Interconnected Porosity

By depositing alumina on the surface of this material, preferably of cubic structure, it is possible to provide the acidity necessary for the hydroconversion reaction.

Advantageously, the material is silica or silica-alumina, preferably of cubic structure.

The alumina may be deposited by treatment with aluminium-based reactants, such as AlCl₃, NaAlO₄, Al(NO₃)₃, Al(OR)₃ in which R is chosen from C₁-C₆ alkyl groups.

In one embodiment of the present invention, the incorporation of alumina is carried out by grafting.

According to a preferred embodiment, the deposition of alumina in the silica is carried out by grafting according to the following steps:
(i) reaction of the mesostructured silica or silica-alumina, with an aluminium-containing compound of formula Al(OR)₃ in which R is chosen from linear or branched C₁-C₆ alkyl groups, in the presence of an activation agent for activating the protons of the silanol groups of the silica in a solvent, the water content of which is less than or equal to 0.005% by weight, preferably less than or equal to 0.0002% by weight;
(ii) separation of the solid by filtration, optionally followed by washing of the solid at least once with the same solvent as that used in the preceding step;
(iii) hydrolysis of the Al(OR) groups grafted onto the silica by mixing the washed solid in a solution containing at least one alcohol of formula R₁OH, R₁ being chosen from linear or branched C₁-C₆ alkyl groups, and a stoichiometric quantity of water;
(iv) filtration and washing of the solid obtained in an alcohol followed by drying; and
(v) calcination of the washed and dried product.

Step (i) corresponds to the reaction:

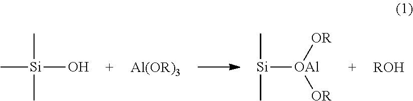

Step (i) is carried out, with stirring, for a time of 1 to 4 hours at a temperature of 20 to 95° C., preferably 45 to 90° C.

The solvent for step (i) is chosen from apolar solvents such as, for example, benzene, toluene, xylene, cyclohexane, n-hexane, pentane, cumene, by themselves or as a mixture, preferably toluene.

This solvent may for example be dehydrated before use, by drying it over a molecular sieve.

Advantageously, alumina is deposited on the mesoporous solid, preferably silica or silica-alumina, using aluminium tri-sec-butoxide as aluminium source and toluene containing triethylamine as solvent.

There are grafting methods in which aluminium tri-iso-propoxide is used as aluminium source [P. lengo, M. Di Serio, A. Sorrentino, V. Solinas and E. Santacesaria, Appl. Catal. A, 167 (1998) 85].

The Applicant has discovered that the use of aluminium tri-sec-butoxide is propitious for forming species anchored (grafted) onto the surface of the solid for an Al(O-sec-Bu)₃/Si—OH ratio equal to or greater than unity.

Since aluminium tri-sec-butoxide has a higher hydrolytic reactivity than aluminium tri-iso-propoxide, it allows the hydrolysis reaction (2) to be carried out in a medium barely saturated with water and thus makes it possible to minimize any structural degradation of the material.

For step (i), the agent for activating the silanol groups of the silica is chosen from organic basic compounds, for example amines, preferably triethylamine, nitriles, etc.

The role of this agent is to activate the protons of the surface silanol groups and thus accelerate reaction (1). It is thus possible to reduce the reaction temperature, which may be 85° C.

Step (iii) corresponds to the reaction:

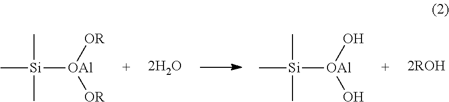

The hydrolysis step (iii) is preferably carried out at room temperature for a time of 0.1 to 48 hours, preferably from 1 to 36 hours.

The expression “room temperature” is understood to mean a temperature ranging from 18 to 25° C., and in particular a temperature of 20° C.

The necessary amount of water used in step (iii) may for example be calculated by considering that Al(OC₄H₉)₃ is completely adsorbed on the solid assuming a stoichiometric amount of water (in a time of less than 2 h).

In step (iv), the drying may be carried out at a temperature of 80 to 130° C. for 1 to 25 h, optionally with a stream of air or nitrogen, or even under vacuum.

The calcination step (v) may be carried out at a temperature de 400° C. to 600° C., preferably 400° C. to 550° C., for a time of 0.5 to 8 hours, for example 1 to 6 hours, under a gas stream.

The alumina deposition step (A), carried out for example by grafting according to steps (i) to (iv), may be repeated several times, generally 2 to 10 times, for the purpose of obtaining a compact alumina layer on the surface of the mesoporous solid.

Synthesis of Mesoporous Silicas having Interconnected Porosity

This synthesis may be carried out by any other method known from the prior art, for example by following the protocol described by Galarneau et al. (A. Galarneau, M. F. Driole, C. Petitto, F. Di Renzo and F. Fajula, Microporous Mesoporous Materials, 83 (2005) 172).

This protocol comprises adding the reactants to a reactor placed in an oil bath at 50° C. The reactants are added according to the following steps:
(1) dissolution of sodium hydroxide in deionized water;
(2) dissolution of CTAB (hexadecyltrimethylammonium bromide) in the solution prepared above;
(3) addition of silica and stirring for two hours;
(4) oven-ageing for a time sufficient to obtain a cubic structure;
(5) filtration of the oven-aged solution and recovery of the solid; and
(6) post-treatment of the solid recovered at (5) by adding deionized water, with stirring, at room temperature, after which the reactor is closed, and heated in an oven at 130° C. for 6 hours.

The ageing time of step (4) is adapted according to the amounts prepared and to the temperature. By carrying out a few trials and by checking the structure of the product obtained at (5), by X-ray diffraction, it is easily possible to determine the necessary time at a given temperature for obtaining a mesoporous silica of cubic structure.

Formulation of the Catalyst

In one embodiment, step (A) of depositing alumina on a mesoporous material, for example by grafting, is followed by a step of forming the alumina-treated material, whether pure or with at least one binder, and optionally with other zeolites. Advantageously, step (B) is carried out, after this forming step, on a formulated catalyst. More specifically, step (A) of depositing alumina on a material based on silica or silica-alumina of interconnected mesoporous texture is followed by a step of forming the alumina-treated material based on silica or silica-alumina of interconnected mesoporous texture, whether this material is pure or combined with at least one binder.

In another embodiment, a step of forming the mesoporous material, whether pure or with at least one binder, and optionally with other zeolites, is carried out before step (A) of depositing alumina. Advantageously, step (B) is carried out after step (A). According to some aspects, a step of forming the material based on silica or silica-alumina of interconnected mesoporous texture, whether pure or combined with at least one binder, is carried out before step (A) of depositing alumina.

The forming step may be carried out by extrusion or any other suitable technique well-known to the skilled person.

The binder may be any refractory oxide or mixture of refractory oxides. The preferred binders are silica, alumina, silica-alumina, aluminophosphates or silica-aluminophosphates, titanium oxide, zirconia, vanadium oxide, etc.

The catalyst may also comprise acid zeolite phases chosen from FAU (faujasite) zeolites (ultrastable, whether dealuminated or desilicated) and BETA zeolites.

The preferred binders are alumina, and amorphous silica-alumina, the latter being preferred, in which the silica content is less than or equal to 50% by weight relative to the total weight of support, preferably less than or equal to 35% by weight and more preferably 15 to 30% by weight. When alumina is used, small amounts of Cl, F, B and P may be incorporated so as to increase the acidity of the support.

Step (B): Incorporation of the Catalytic Metal

According to the invention, the catalyst comprises at least one catalytically active species, in other words a catalytic metal, chosen from the metals of group VIII and/or of group VIB, alone or in a mixture.

Group VIIIB corresponds to groups 8, 9 and 10 of IUPAC periodic table of the elements (version of Jun. 22, 2007) and comprises Fe, Ru, Os, Co, Rh, Ir, Ni, Pd, Pt.

The metals from group VIII are for example the noble metals which may be present in amounts of 0.1 to 2% by weight relative to all of the metals. These noble metals are especially Pt, Rh, Pd and Ir, preferably Pt and Pd, particularly as a mixture.

Other metals of group VIII are Co, Ni and Fe, Ni and Co being preferred. The metals of group VIII may be present in amounts of 0.5 to 5% by weight relative to all of the metals.

The metals of group VIB are for example Mo, W and Cr, Mo and W being preferred. The metals of group VIB may be present in amounts of 1 to 20% by weight relative to all of the metals.

The incorporation of a catalytic metal may be accompanied by the incorporation of one or more dopant metals and/or dopant elements.

The dopant metals may be chosen from the rare earths or from group IVB or IB. They may for example be Ti and/or Cu.

These dopant metals may be present in amounts of 1 to 10% by weight relative to all of the metals.

The dopant elements can be chosen from chlorine, fluorine, boron and phosphorus and may be present in amounts of 0.1 to 5% by weight relative to the total weight of the catalyst.

The metals may be incorporated by any suitable method, such as impregnation or ion exchange, at any stage in the preparation.

The metals are preferably introduced by the “dry” impregnation method, with which the skilled person is very familiar. Impregnation may be carried out advantageously in a single step with a solution containing all of the constituent elements of the final catalyst.

The metals may also be introduced, advantageously, by one or more operations of impregnating the formed and calcined support, with a solution containing at least one precursor of at least one oxide of at least one metal chosen from the group formed by the metals of group VIII and/or the metals of group VIB.

The sources of elements of group VIII that can be used advantageously are well known to the skilled person:
For non-noble metals, it is advantageous to use nitrates, sulphates, phosphates, halides, carboxylates, hydroxides and carbonates.
For noble metals, they may be introduced in the form of cations, anions or neutral complexes. It is advantageous to use halides, for example chlorides, nitrates, acids and oxychlorides. It is also possible with advantage to use cationic complexes such as ammonium salts when it is desired to deposit the platinum metals on the zeolite by cationic exchange. In the case of platinum, the precursor, for example, will be tetraaminoplatinum(II) nitrate or chloroplatinic acid H₂PtCl₆.

Step (B) of adding a metal may optionally be carried out simultaneously with the alumina deposition step (A), for example by grafting.

Step (C): Thermal and Chemical Treatments of the Catalyst

The calcination final step may be carried out at 450° C. to 600° C. for a time of 1 to 12 hours, optionally in a gas stream (air or nitrogen) or under vacuum.

The calcination step (C) is usually followed by a step (D) of activating the catalyst, comprising a sulphurization step generally followed by a reduction step using hydrogen.

Since all hydrocracking catalysts contain metals, especially noble metals, whether in the oxide state or not, they must necessarily undergo sulphurization before use, so as to make them active. This sulphurization may be carried out either in situ, in the refinery hydroprocessing/hydroconversion reactor, or ex situ. The sulphurization may be carried out by means of hydrogen sulphide, mercaptans, organic sulphides, polysulphides and/or elemental sulphur, these compounds being introduced singly, or mixed with a solvent, or at the same time as the feedstock.

Before the sulphurization step, certain of these catalysts are premodified by treating them with chelating or complexing organic compounds.

The sulphurization and the premodification may take place in situ, that is to say in the hydroprocessing/hydroconversion reactor, or else ex situ, that is to say in a dedicated reactor. It is also conceivable to combine ex situ premodification with in situ sulphurization in the hydroprocessing/hydroconversion reactor.

The reduction step generally comprises heating to a temperature of 300° C. to 550° C. for 0.5 to 20 hours, preferably 1 to 14 hours, in a stream of pure or diluted hydrogen.

The invention also relates to a hydroconversion catalyst obtained by the method according to the invention, comprising a mesoporous material having interconnected pores, said material being coated with alumina and having a Si/Al ratio of between 0.1 and 1000, and at least one catalytically active species chosen from the metals of group VIII and/or of group VIB.

The mesoporous material may be of cubic structure.

Advantageously, the catalyst includes a support which is composed of silica or silica-alumina having a Si/Al ratio of between 0.1 and 1000, with a three-dimension interconnected mesoporous porosity on which the alumina is deposited, preferably including grafted Al(OR)₂ groups, where R is chosen from linear or branched C₁-C₆ alkyl.

Preferably, the catalyst comprises a support consisting of mesoporous silica with a three-dimension interconnected porosity, onto which Al(OR)₂ groups are grafted, where R is chosen from linear or branched C₁-C₆ alkyl groups.

Preferably, silica or silica-alumina is of cubic structure.

According to some preferred embodiments, the catalyst includes the mesoporous material composed of mesoporous MCM-48 silica, preferably presenting a cubic structure, said material being coated with alumina and having a Si/Al ratio of between 0.1 and 1000, and at least one catalytically active species chosen from the metals of group VIII and/or of group VIB.

Finally, the invention relates to a method of hydroconverting (hydroisomerizing, hydrocracking) a hydrocarbon feedstock, which comprises bringing the feedstock to be treated into contact with a hydroconversion catalyst obtained by the method according to the invention.

Hydrocracking is the conversion of the heavy cuts which are in excess and often not very profitable into lighter cuts which have high added values (middle distillates of very high quality).

Hydroisomerization is the conversion of n-paraffins into branched paraffins, which exhibit good low-temperature properties.

Advantageously, the feedstock to be treated is a typical hydrocracking feedstock, which distils at a temperature above 150° C. The feedstock may contain a substantial amount of nitrogen in the form of organic nitrogen compounds. The feedstock may also contain a significant amount of sulphur, for example 0.1 to 3% by weight, or even more.

Optionally, the feedstock may be pretreated in a known or conventional manner so as to reduce its sulphur and/or its nitrogen content.

Examples of hydrocarbon feedstocks are those derived from at least the heat treatment, catalytic treatment, extraction treatment, dewaxing treatment or fractionation treatment of crude oils, such as atmospheric residues, vacuum residues, hydrocracking distillates, vacuum or atmospheric distillation residues, vacuum distillates, atmospheric distillates, raffinates, atmospheric gas oils, vacuum gas oils, coking gas oils, used oils, deasphalted residues or crudes, deasphalted oils, residual waxes, waxes, paraffins and Fischer-Tropsch waxes. Such feedstocks may be derived from distillation (vacuum and atmospheric) towers, other hydrocracking or hydroprocessing reactors or from solvent extraction units.

The feedstock for treatment may advantageously also have come from a renewable source (oils and fats of plant or animal origin) which has beforehand undergone a hydrotreating step (hydrodeoxygenation, decarboxylation/decarbonylation).

In the present invention, the feedstock undergoes hydroconversion in the presence of a catalyst according to the invention at a temperature of 200° C. to 480° C., under a hydrogen pressure of 10 to 200 bar, with a liquid hourly space velocity (LHSV) of 0.2 to 10 and an H₂/feedstock ratio of 0.4 to 50 mol/mol.

The invention will now be described by means of non-limiting examples and with reference to the non-limiting appended drawings in which:

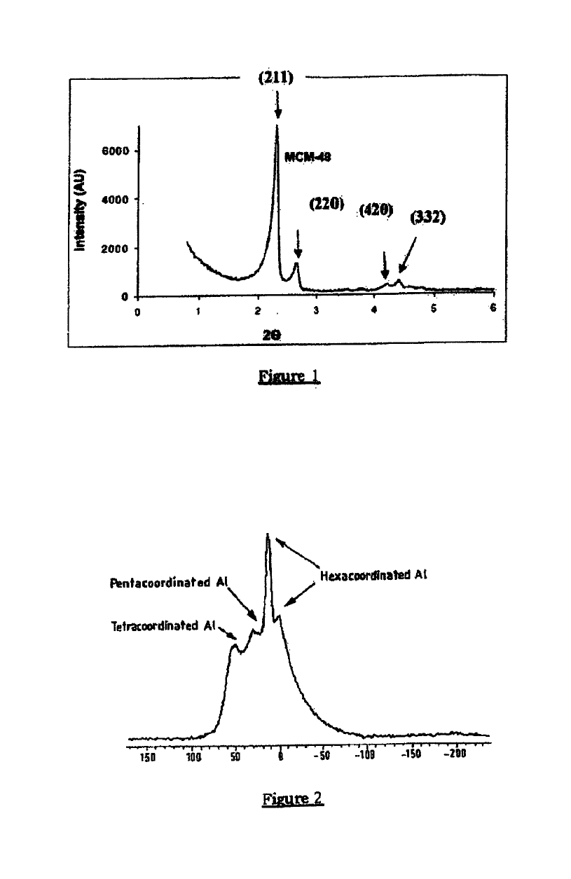

FIG. 1 shows the X-ray diffractogram of the mesoporous silica having a cubic structure prepared from Example 1 (MCM-48);

FIG. 2 shows the ²⁷Al NMR spectrum obtained for the MCM-48Al solid, characteristic of an alumina phase;

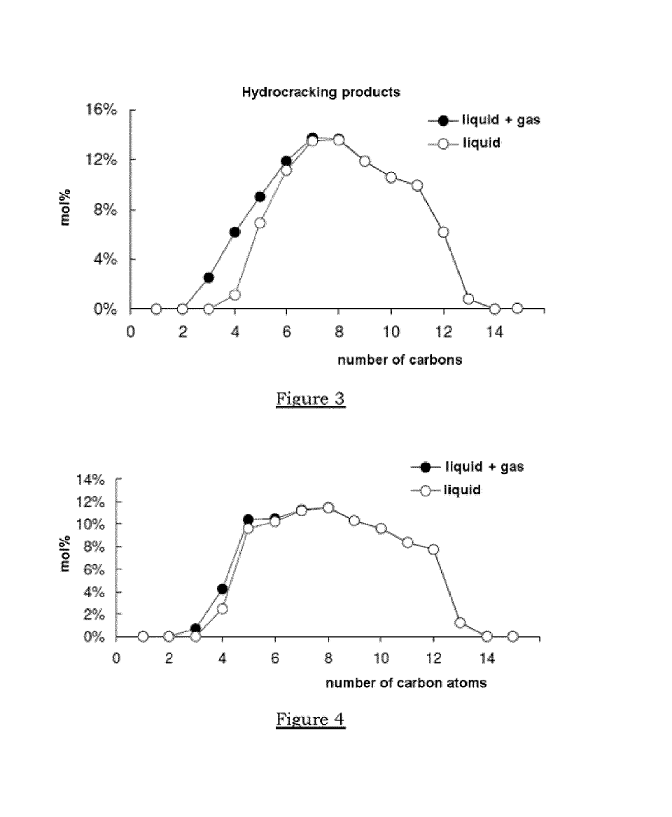

FIG. 3 shows the distribution of the cracking products of n-hexadecane at 99.8% total conversion in the hydroconversion of nC₁₆ or 92.7% yield in terms of cracking products (C₆/C₁₀=1.13; test 2, Table 6) with a Pt/MCM-48A catalyst;

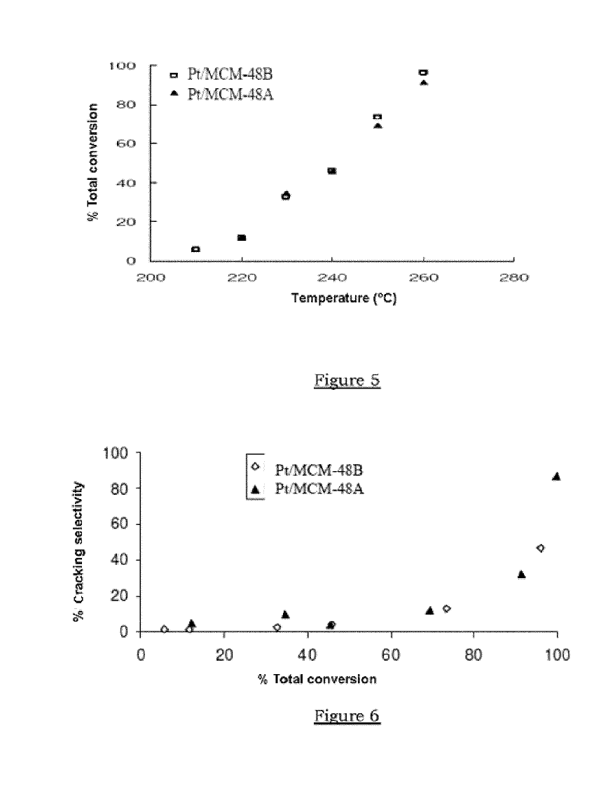

FIG. 4 shows the distribution of the cracking products of n-hexadecane at 98% total conversion or 75% yield in terms of cracking products (C₆/C₁₀=1.1; test 2; Table 7) with a Pt/MCM-48B catalyst;

FIG. 5 shows the activity of the Pt/MCM-48A and Pt/MCM-48B catalysts in the hydroconversion of n-hexadecane;

FIG. 6 shows the n-hexadecane cracking product selectivity of the Pt/MCM-48A and Pt/MCM-48B catalysts;

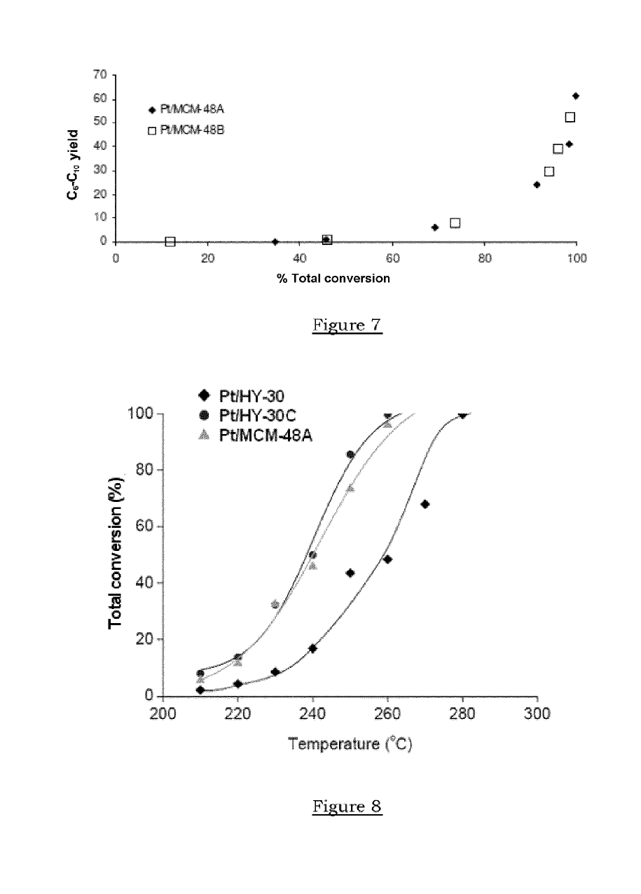

FIG. 7 shows the yield of the C₆-C₁₀ cut as a function of the total conversion for Pt/MCM-48A and Pt/MCM-48A catalysts;

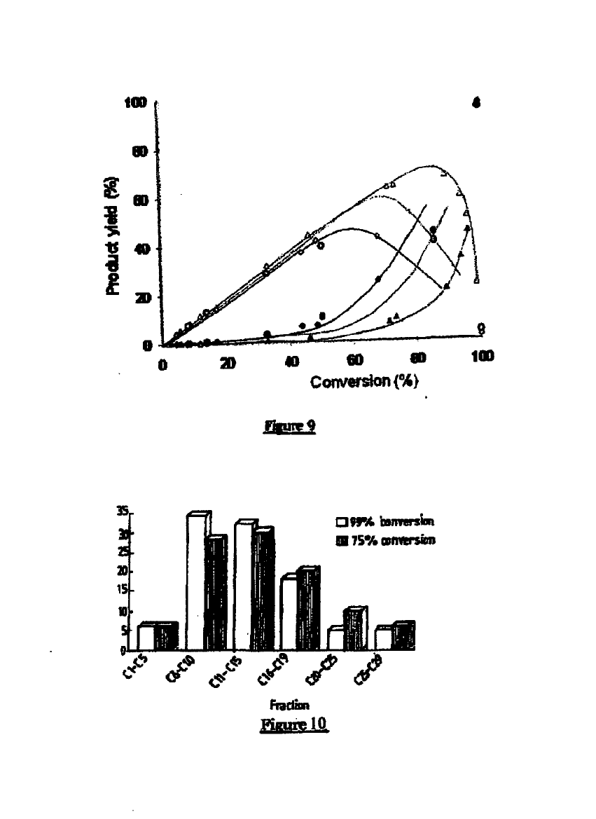

FIG. 8 shows the degree of conversion of n-hexadecane as a function of temperature for Pt/HY30, Pt/HY30C and Pt/MCM-48A catalysts;

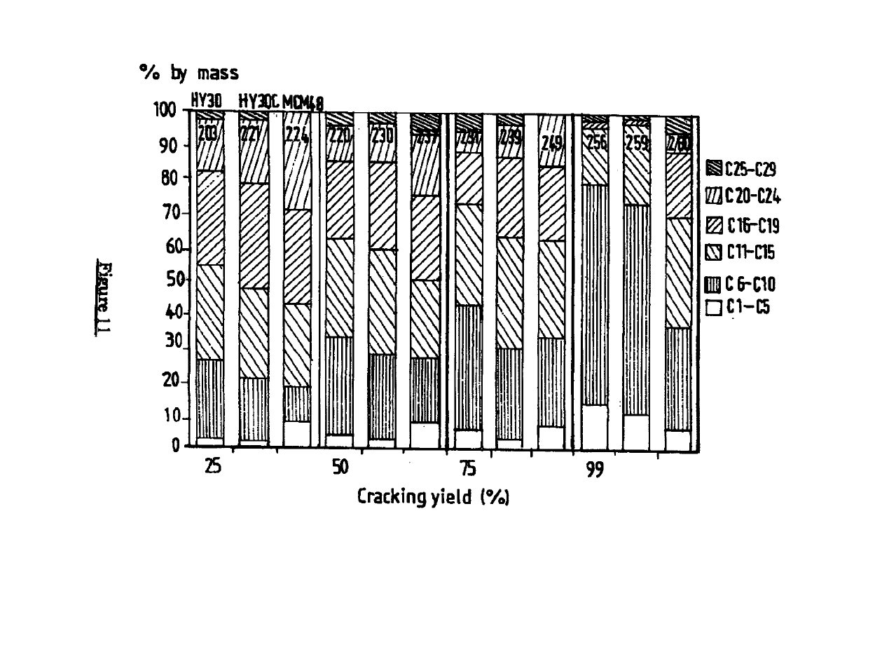

FIG. 9 shows the cracking product yields (solid symbols) and isomerisation product yields (open symbols) for n-hexadecane: Pt/HY-30 (diamonds), Pt/HY-30C (circles), Pt/MCM-48A (triangles);

FIG. 10 shows the distribution of squalane cracking products at 99% (left-hand columns) and 75% (right-hand columns) total conversion for a Pt/MCM-48A catalyst;

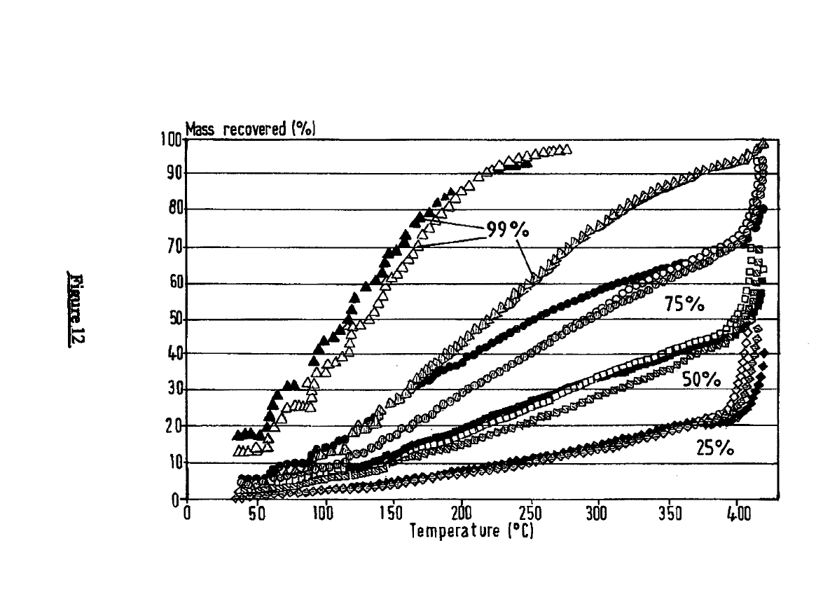

FIG. 11 shows the distribution of the cracking products for various degrees of conversion of squalane, for Pt/HY30, Pt/HY30C and Pt/MCM-48A catalysts;

FIG. 12 shows the simulated distillation curves for the products of the liquid phase, these being obtained for various cracking yields of squalane, in the presence of Pt/MCM-48A (grey symbols), Pt/HY30 (solid black symbols) and Pt/HY30C (open symbols) catalysts.

### EXAMPLES

### Example 1

### Preparation of a Mesoporous Silica of MCM-48 Cubic Structure

The reactants used for the MCM-48 synthesis were:

(A) Aerosil 200 silica (Degussa);

(B) hexadecyltrimethylammonium bromide (CTAB; Aldrich);

(C) sodium hydroxide (Carlo Erba); and

(D) deionized water.

The molar composition of the synthesis gel was the following: Si/0.38 Na/0.175 CTAB/120 H₂O.

The operating method is described below.

A reactor of 300 mL volume was placed in an oil bath at 50° C. Next, 214.2 g of deionized water and 1.544 g of sodium hydroxide were introduced into the reactor and then, after the NaOH had dissolved, 6.223 g of CTAB were added. After the CTAB had completely dissolved, 6 g of silica were added. The solution was stirred for 2 h with a bar magnet. The reactor was then closed and placed in an oven at 150° C. for a time of 7 to 10 hours.

The duration of this oven treatment step may vary depending on the solution volume prepared. This time was chosen so as to obtain a cubic structure. A characterization of the solid obtained by X-Ray diffraction (DRX) enabled the structure of the solid to be checked and the oven treatment time to be adapted. In particular, too short a time led to a hexagonal structure being obtained, whereas too long a time led to a lamellar structure being obtained.

The solution was then filtered and the recovered solid was post-treated in deionized water.

The post-treatment was carried out in the following manner: 7.5 g of water per gram of solid were added; the mixture was stirred for 30 minutes at room temperature; the reactor was closed and then placed in an oven at 130° C. for six hours. The post-treatment was repeated twice according to the protocol described by Galarneau et al. [A. Galarneau, M. F. Driole, C. Petitto, F. Di Renzo and F. Fajula, Microporous Mesoporous Materials, 83 (2005) 172].

The solid obtained was called MCM-48.

### Example 2

### Preparation of the MCM-48Al Composite Material

Grafting of the alumina was carried out by stirring 3 g of MCM-48 in a solution of 150 mL of toluene dried over a molecular sieve (H₂O<0.002%) containing 2 g of triethylamine (Aldrich) and 10 g of Al(O—C₄H₉)₃ (Aldrich) at 85° C. for 6 h.

The mixture was then separated by filtration and washed with toluene (in small amounts, several times). After being washed, the solid obtained was put into a solution of 200 mL of ethanol to which 2 mL of water were added, the solution was stirred at 25° C. for 24 h, enabling Al(OR) groups to be hydrolyzed.

The necessary amount of water was calculated considering that Al(O—sec-C₄H₉)₃ is completely adsorbed on the MCM-48 solid. The solid obtained was washed with ethanol (in small amounts, several times), dried in air at 120° C. and then calcined according to the programme: 1°/min, 250° C. for 1 h, 400° C. for 1 h and finally 500° C. for 4 h.

A material called MCM 48Al was thus obtained.

### Example 3

### Preparation of the Pt/MCM-48A Catalyst (Addition of Pt)

The catalyst Pt/MCM-48A was prepared by dry impregnation of 0.5% platinum on the MCM-48Al material together with, as precursor, tetraamineplatinum(II) nitrate (the metal content in the precursor was 99.9%).

For this purpose, 5 g of MCM-48Al were impregnated with 4 mL of an aqueous solution containing 0.025 g of Pt(NH₃)₄(NO₃)₂. The solid obtained was dried at 80° C. in an oven for 2 h and then at 120° C. for 12 h. The material obtained was then calcined in air at 550° C. for 8 h. Activation of the catalyst was carried out at 500° C. for 12 h in a stream of hydrogen.

### Example 4

### Preparation of the Pt/MCM-48B Catalyst (Addition of Pt and Cl)

The Pt/MCM-48B catalyst was obtained in the following manner: 5 g of the MCM-48Al material were impregnated with 4 mL of a 0.2M HCl solution containing 0.0625 g of chloroplatinic acid H₂PtCl₆ (the platinum content in the H₂PtCl₆ was 40%).

This precursor served both to chlorinate the solid and add the hydrogenating function thereto. The solid obtained was dried at 80° C. in an oven for 2 h and then at 120° C. for 12 h. The material obtained was then calcined in air at 500° C. for 4 h. The purpose of the chlorination was to check the possibility of increasing the acidity of the catalyst. The activation of the catalyst was performed at 500° C. for 12 h in a stream of hydrogen.

### Example 5

### Characterization of the Solids Prepared in Examples 1 to 4

X-Ray Diffraction

The measurements were carried out on a Bruker D8 Advance diffractometer fitted with a monochromator using the copper K_{c} line for a wavelength a=1.5405 Å.

The X-ray diffractogram (FIG. 1) of the mesoporous silica (MCM-48) of cubic structure prepared in Example 1 shows four diffraction peaks. The most intense peak is indexed as (211) and the other peaks as (220), (420) and (332) respectively and are characteristic of a mesoporous silica of MCM-48 type. The d₂₁₁ and d₂₂₀ diffraction peaks appear at 2θ=2.29° and 2θ=2.64° respectively, and the d₂₁₁/d₂₂₀ ratio is equal to 0.867. This ratio between 0.86 and 0.87 confirmed that the solid obtained had a cubic structure [H. Kosslick, G. Lischke, H. Landmesser and B. Parlitz, J. Catal., 176 (1998), 102; C. Danumah, S. Vauderuil, L. Bonneviot, S. Giasson and S. Kaliaguine Microporous Mesoporous Materials, 44 (2001) 241].

The XRD spectra of the MCM-48Al, Pt/MCM-48A and Pt/MCM-48B solids were obtained. In all cases, the presence of four diffraction lines characteristic of the cubic structure of MCM-48 was observed.

This structure remained even after alumina grafting, platinum impregnation, with or without addition of chlorine, and calcination.

The addition of platinum (Pt/MCM-48A) or of platinum and chlorine (Pt/MCM-48B) results in a slight shift in the diffraction lines towards higher 2θ values (Tables 1 and 2).

The XRD spectra made it possible to calculate the lattice parameter a₀ from the lattice plane spacing (Bragg's law).

In the case of a cubic system such as MCM-48, the lattice parameter a₀ is expressed as a₀=d₂₁₁. (6)^{1/2}.

The shift of the diffraction lines towards high 2θ values implies a reduction in the lattice plane spacing, leading to a slight contraction of the lattice parameter a₀ but with no structural modification.

Structural Characteristics/Adsorption Isotherms

The nitrogen adsorption/desorption isotherms at −196° C. serve to characterize the textural properties of the various solids.

The nitrogen adsorption/desorption isotherms were carried out on Micromeritics ASAP 2000 and ASAP 2010 instruments.

The specimens were degassed beforehand at about 0.5 Pa and 250° C. for a minimum of 8 h so as to eliminate the impurities on the surface of the solid.

The MCM-48 solids had a type IV isotherm [S. Brunauer, L. S. Deming, W. E. Deming and E. Teller, J. Am. Chem. Soc., 62 (1940) 1723] subdivided into 4 zones:
p/pₒ<0.3: providing information about the total surface area of the solid and corresponding to monolayer-multilayer adsorption;
p/pₒ≈0.4: corresponding to the filling of the pores by capillary condensation, manifested by a sudden step in the isotherm, providing information about the pore size;
0.4<p/pₒ<0.9: adsorption at the external surface of the solid; and
p/pₒ>0.9: filling of the interparticulate porosity.

The processing of the isotherm data will be explained in detail later.

Calculation of the Mesoporous Volume

Vₘₑₛₒ is equal to V_{ads}/647 (mL/g) where Vₘₑₛₒ represents the mesoporous volume, V_{ads} represents the adsorbed volume and 647 represents (in the normal temperature and pressure conditions) the ratio of the liquid nitrogen volume to the gaseous nitrogen volume, with:

ρ(N₂ liquid)=0.808 g/cm³ and

ρ(gaseous N₂=1.25×10⁻³ g/cm³.

The surface area was calculated using the BET method [S. Brunauer, P. H. Emmet and E. Teller, J. Am. Chem. Soc., 60 (1938) 309)].

The pore diameter was calculated using the BdB (Broekhoff and de Boer) method [L. Allouche, C. Huguenard and F. Taulelle, J. Phys. Chem. Solids, 62 (2001) 1525] applied to the desorption curve of the isotherm.

The wall thickness (t) is related to the lattice parameter a₀ and the pore diameter Dₚ through the following equation: t=aₒ/2−Dₚ.

The textural characteristics of the synthesized materials were extracted from the isotherms recorded for the various solids and are given in Tables 1 and 2.

In these tables:
(A) Pt/MCM-48A (not reduced) or Pt/MCM-48B (not reduced): corresponds to the platinum not yet in its metallic form;
(B) Pt/MCM-48A (reduced and used): corresponds to the activated catalyst used in an n-hexadecane hydrocracking reaction. After reaction, the catalyst was left in a stream of hydrogen at high temperature.

TABLE 1
Textural characteristics

| | | BET | Corrected | | | |
|---|---|---|---|---|---|---|
| | | surface | BET | | | |
| | Vₘₑₛₒ | area | surface | | a₀ | t |
| Material | (mL/g) | (m²/g) | area (m²/g) | Dₚ (nm) | (nm) | (nm) |
| MCM-48 | 0.86 | 1035 | 1035 | 3.7 | 9.7 | 1.15 |
| MCM-48Al | 0.64 | 958 | 1076 | 3.5 | 9.4 | 1.20 |
| Pt/MCM-48A | 0.54 | 836 | — | 3.3 | 9.1 | 1.25 |
| (not reduced) | | | | | | |
| Pt/MCM-48A | 0.49 | 805 | — | 3.2 | 9.0 | 1.30 |
| (reduced and | | | | | | |
| used) | | | | | | |

TABLE 2
Textural characteristics

| | | BET | Corrected | | | |
|---|---|---|---|---|---|---|
| | | surface | BET | | | |
| | Vₘₑₛₒ | area | surface | | a₀ | t |
| Material | (mL/g) | (m²/g) | area (m²/g) | Dₚ (nm) | (nm) | (nm) |
| MCM-48 | 0.96 | 1115 | 1115 | 3.8 | 9.83 | 1.11 |
| MCM-48Al | 0.73 | 980 | 1126 | 3.3 | 9.10 | 1.35 |
| Pt/MCM-48B | 0.54 | 814 | — | 3.2 | 9.30 | 1.35 |
| (not reduced) | | | | | | |

The two tables show a reduction in the mesoporous volume as the treatments proceed. This reduction in the pore volume is consistent with the observed reduction in the pore diameter and with the increase in wall thickness.

The surface area of the solids, calculated by the BET method, firstly shows a reduction in this surface area with the addition of aluminium; the value of the surface area was corrected taking into account the amount of aluminium added. The surface area correction was performed as follows:

S_{BET}corrected=S_{BET}MCM-48Al/(1−y);

S_{BET}MCM−48Al−surface area of the grafted solid; and

y: mass fraction of alumina incorporated (see the elemental analysis).

After correction, it was found that the surface area of the solid did not change after alumina grafting. This observation was valid in both cases (Tables 1 and 2).

Elemental Analysis

The elemental analyses were carried out by ICP-MS (inductively coupled plasma mass spectrometry).

The results of the elemental analysis on the solids are given in Tables 3 and 4. The solids obtained after grafting contained about 11 wt % alumina in the first case and 13 wt % in the second case.

The elemental analysis data for the Pt/MCM-48A catalyst are given in Table 3. The amount of alumina incorporated was 11%.

For both synthesis batches, we were able to incorporate approximately the same amount of aluminium, testifying to the reproducibility of the alumina treatment method.

In both cases, the final amount of sodium contained in the solids was less than 200 ppm and that of the platinum incorporated varied from 0.4 to 0.2%.

TABLE 3
Elemental analyses of the Pt/MCM-48Al and Pt/MCM-48A
(not reduced and reduced) solids

| | Si (%) | Al (%) | Si/Al | Na (ppm) | Pt % |
|---|---|---|---|---|---|
| Pt/MCM-48Al | 27.90 | 5.58 | 5.00 | <220 | — |
| Pt/MCM-48A (not | 25.86 | 5.05 | 5.12 | <200 | 0.20 |
| reduced) | | | | | |
| Pt/MCM-48A | 25.05 | 4.80 | 5.21 | | 0.19 |
| (reduced) | | | | | |

TABLE 4
Elemental analyses of the Pt/MCM-48Al and Pt/MCM-48B (not reduced)
solids

| | Si(%) | Al(%) | Si/Al | Na(ppm) | Cl(%) | Pt(%) |
|---|---|---|---|---|---|---|
| Pt/MCM-48Al | 32.60 | 6.74 | 4.84 | <220 | — | — |
| Pt/MCM-48B (not | 24.60 | 5.02 | 4.90 | <200 | 0.31 | 0.37 |
| reduced) | | | | | | |

NMR (²⁷Al MAS NMR)

Analyses were carried out on hydrated specimens using a Bruker ASX 400 instrument, possessing a magnetic field of 9.4 T, a rotation rate of 12 kHz, impulses of π/2 at 1 s intervals and number of acquisitions greater than 50000.

The ²⁷Al NMR provided us with information about the environment of the aluminium within the material.

FIG. 2 showing the spectrum obtained for the MCM-48Al solid is characteristic of an alumina. Four signals were observed: two signals at 0.3 ppm and 2.4 ppm, characteristic of hexacoordinated aluminium, one signal at 34 ppm characteristic of pentacoordinated aluminium and a fourth signal at 53 ppm characteristic of tetracoordinated aluminium. The most intense signal was that from hexacoordinated aluminium.

The addition of platinum to the MCM-48Al solid and the calcination thereof resulted in a spectrum having the same four lines, but with an increase in the intensity of the tetracoordinated aluminium peak (at 53 ppm). This increase in the intensity of the peak at 53 ppm could be due to the insertion of part of the octahedral aluminium into the lattice or to the reorganization of the Al—O—Si bonds.

After the n-hexadecane hydrocracking reaction, the peak representative of the tetracoordinated aluminium (signal at 53 ppm) further increases in intensity, which could be explained by the evolution of the structure during the hydrocracking reaction.

NMR (²⁹Si MAS NMR)

In silicon NMR, the notation Qⁿ corresponds to a central silicon atom surrounded by n O—Si groups. In particular, Q³ corresponds to a central silicon atom surrounded by 3 O—Si groups and one O—X group, X being an atom other than silicon.

The ²⁹Si NMR spectrum of the MCM-48 mesoporous silica consisted of two peaks, one peak at −110 ppm possibly attributed to Si(OSi)₄ groups (Q⁴) and a weaker peak at −100 ppm, corresponding to Q³.

For the non-reduced Pt/MCM-48A catalyst (containing aluminium and calcined at 550° C. for 8 h), the ²⁹Si NMR spectrum had a very broad single peak resulting from the superposition of the Q³ and Q⁴ peaks. This could be explained by the increase in the Q³ signal resulting from the addition of aluminium (Si(OSi)₃O—Al).

The ²⁹Si NMR spectra of the reduced and used Pt/MCM-48A solid were identical to that of the non-reduced Pt/MCM-48A catalyst. This would indicate that there is no change in the silicon environment during the reduction and the catalysis.

The spectra of the second synthesis batch (Pt/MCM-48B) were the same as those for the first batch (Pt/MCM-48A).

NH₃ TPD

The acidity measurements were carried out using, as probe molecule, ammonia which is a strong base and enabled all the acid sites of the solid to be assayed. Temperature-programmed desorption of ammonia served to determine the number and the strength of the acid sites present on a solid.

The analyses were carried out on a Micromeritics AutoChem II 2910 instrument.

The solid was calcined in air at 10° C./min up to 550° C. and, after cooling to 100° C., ammonia was adsorbed on the solid for 45 minutes using a mixture consisting of 95% helium and 5% ammonia. The physisorbed species were removed using a stream of nitrogen for 120 minutes. The chemisorbed ammonia desorption was carried out under a stream of nitrogen and the temperature rise was 10° C./min.

The TPD of the purely silica mesoporous solid MCM-48 was characteristic of a non-acid material, no desorption peak being observed.

The reduced and used catalysts Pt/MCM-48A and Pt/MCM-48B had respective acidities of 0.83 and 0.7 mmol/g.

The two curves showed peaks with an optimum at 250° C., corresponding to the adsorption of ammonia on the acid sites of moderate strength.

The number of acid sites per gram of solid was almost the same for the two, reduced and used, catalysts obtained. For the non-reduced (fresh) Pt/MCM-48A catalyst, the density of the acid sites was slightly higher, equal to 0.95 mmol/g.

Determination of the Acidity by Infrared Spectroscopy

To refine the results obtained by NH₃ TPD, the Brönsted and Lewis acid sites were studied by deuterated acetonitrile adsorption monitored by FTIR.

The analyses were carried out on a Bruker Vector 22 instrument.

The specimen (about 100 mg of solid), in the form of a self-supporting disc using a press, was inserted into a glass cell having KBr windows. The specimen was treated in vacuum at 450° C. for 12 h. After returning to 150° C., a small amount of deuterated acetonitrile (CD₃CN) was adsorbed on the solid and then the specimen was put back under vacuum at the same temperature in order to remove the physisorbed deuterated acetonitrile. The deuterated acetonitrile was then desorbed by raising the temperature of the specimen and an infrared spectrum of the specimen was taken at room temperature after desorption of the deuterated acetonitrile.

The infrared spectra for the reduced and used Pt/MCM-48B catalyst and for the reduced and used Pt/MCM-48A catalyst were recorded at 25° C., 50° C., 100° C. and 150° C. respectively. The spectra of the two catalysts were identical.

At all temperatures and even for the blank (blank=solid on which acetonitrile was not adsorbed), an intense band at 3743 cm⁻¹ corresponding to the stretching of the weakly acid surface silanol groups was observed.

The deuterated acetonitrile adsorption on the solids at 25° C. resulted in a reduction in the band at 3743 cm⁻¹ and the appearance of a broad band at 3430 cm⁻¹ (Δ=313 cm⁻¹) resulting from the interaction between the surface silanols and the deuterated acetonitrile via Si—OH . . . NCCD₃ hydrogen bonds.

The deuterated acetonitrile adsorption also resulted in the appearance of two bands in the CN vibration frequency region at 2323 cm⁻¹ and 2283 cm¹, no peak being observed in this zone in the case of the blank.

The band at 2323 cm⁻¹ corresponds to the interaction between deuterated acetonitrile and the Al³⁺ ions and is characteristic of the Lewis acid sites generally present in alumina form, whereas the band at 2283 cm⁻¹ is attributed to the adsorption of acetonitrile on the Brönsted acid sites. The band at 2323 cm⁻¹ remains intense even after desorption at 150° C., whereas the band corresponding to the Brönsted acid sites completely disappears after desorption at high temperature, thereby seeming to show that these materials have weak Brönsted acid sites.

A band at 2251 cm⁻¹ corresponding to the vibration of the deuterated acetonitrile and a band at 2115 cm⁻¹ due to the physisorbed deuterated acetonitrile were also observed.

This analysis served to confirm the presence of Lewis acid sites and weak Brönsted acid sites.

### Example 6

### Preparation of Zeolite-Type Comparative Catalysts Pt/HY30 and Pt/HY30C

The catalyst Pt/HY30 was prepared by incorporating 0.5% by weight of platinum in a specimen of a commercial CBV 760 zeolite (Si/Al=30) supplied by Zeolyst International.

The catalyst Pt/HY30C was obtained as described below. A sample of the commercial CBV 760 zeolite (Si/Al=30) supplied was subjected to an alkaline treatment for 15 minutes using 0.05M NaOH at room temperature. An ion-exchange treatment with 0.5M NH₄Cl was then carried out, after which the specimen was washed and calcined at 550° C. for 6 hours. The catalytic metal (Pt) was then incorporated into the resulting solid.

Pt/HY30 and Pt/HY30C each contained 0.5 wt % platinum.

Pt/HY30C retained its cristallinity and had a higher mesoporous volume than Pt/HY30. The characteristics of these catalysts are given in Table 5.

TABLE 5
Characteristics of Pt/HY30 and Pt/HY30C

| Catalyst | Pt/HY30 | Pt/HY30C |
|---|---|---|
| S_{BET} (m²/g) | 193 | 329 |
| V_{micro} (cc/g) | 0.191 | 0.127 |
| Vₘₑₛₒ (cc/g) | 0.206 | 0.364 |
| Acidity (mmol/g) | 0.297 | 0.200 |

Catalytic Tests for the Hydroconversion of Hexadecane (n-C₁₆) and Squalane on the Pt/MCM-48A and Pt/MCM-48B Catalysts

All the catalytic tests were carried out in a micropilot. Between 1 and 1.3 g of catalyst were put into a tubular reactor placed at the centre of a furnace and held in position by two inert (quartz) and quartz wool layers. A thermocouple placed at the centre of the catalyst bed controlled its temperature to within one degree. The reactor was supplied with a downflow with a mixture of hydrogen and the feedstock (n-hexadecane or squalane) to be treated, this mixture being preheated to about 130° C. in a mixing loop. All the lines transporting a liquid-gas mixture were heated to about 130° C. Moreover, the feedstock, before being mixed with the hydrogen, was dried over a 3 Å molecular sieve and then filtered (0.45 nm filter).

After the hydroconversion reaction, a separator provided the liquid/gas separation of the reaction products. The reaction products were analyzed by gas chromatography, and the other part of the gas is passed through a counter and was removed. The separator itself was regularly emptied without depressurizing the system and the liquid specimens were analyzed by GC and weighed for the purpose of calculating the mass balance.

### Example 7

### Catalytic Test for the Hydroconversion of Hexadecane (n-C16)

The hydrocracking of n-hexadecane (CH₃(CH₂)₁₄CH₃) was carried out in a fixed-bed catalytic reactor in the micropilot described above.

The catalysts were reduced under hydrogen in situ at 500° C. for 12 h and the reaction products were analyzed by GC (injector: 295° C., FID detector: 300° C., ramp: 40° C. for 3 min, 90° C. for 3.5 min and 20° C./min up to 180° C.).

Experimental Conditions:
Pressure: 20 bar
Hydrogen/hydrocarbon ratio: 4
T: 210-280° C.
WHSV: 1-3 h⁻¹.

The tables below show the results obtained for catalysis using the Pt/MCM-48A (Table 6) and Pt/MCM-48B (Table 7) catalysts. These two tables give the results obtained, for each test carried out, namely: the mass balance;

the contact time (t_{c}); the total conversion (% conv.); the cracking products selectivity (% crack. sel.); the isomerisation products selectivity (% isom. sel.); the cracking products yield (% crack. yld.); and the middle cut yield (% C₆-C₁₀ yld.) The H₂/HC ratio is a molar ratio.

For the hydroconversion of n-C₁₆, the yield of the C₆-C₁₀ cut is here a parameter that makes it possible to determine the production of middle distillates and the C₆/C₁₀ ratio is a parameter enabling the cracking products selectivity to be determined.

Depending on the latter parameter, cracking will be termed symmetrical if the C₆/C₁₀ ratio is close to 1 and unsymmetrical otherwise.

TABLE 6
Catalysis results obtained for the Pt/MCM-48A catalyst

| | Mass | | | | | | % | % | | % | % |
|---|---|---|---|---|---|---|---|---|---|---|---|
| | balance | | t_{c} | | WHSV | % | crack. | iso. | | crack. | C₆/C₁₀ |
| Test | (%) | T (° C.) | (min) | H₂/HC | (h⁻¹) | conv. | sel. | sel. | C₆/C₁₀ | yld. | yld. |
| 1 | 98.7 | 280 | 20.5 | 4 | 2.9 | 98.3 | 87.0 | 13.0 | 1.9 | 85.5 | 40.7 |
| 2 | 99.1 | 270 | 20.5 | 4 | 2.9 | 99.8 | 92.9 | 7.1 | 1.1 | 92.7 | 61.2 |
| 3 | 99.8 | 260 | 19.8 | 4 | 3.0 | 91.3 | 32.2 | 67.8 | 1.1 | 29.4 | 23.8 |
| 4 | 99.3 | 250 | 20.1 | 4 | 3.0 | 69.3 | 11.9 | 88.1 | 1.1 | 8.3 | 6.0 |
| 5 | 99.9 | 240 | 19.9 | 4 | 3.0 | 45.6 | 3.5 | 96.5 | 1.1 | 1.6 | 0.94 |
| 6 | 98.1 | 230 | 20.5 | 4 | 2.9 | 34.7 | 3.3 | 96.7 | 1.2 | 1.2 | 0.12 |
| 7 | 98.0 | 220 | 20.5 | 4 | 2.9 | 12.2 | 3.1 | 96.9 | | | |
| Pt return | 99.5 | 260 | 20.3 | 4 | 3.0 | 93.1 | 49.2 | 50.8 | 1.4 | 45.8 | 31.03 |
| (140 h) | | | | | | | | | | | |

TABLE 7
Catalysis results obtained for the Pt/MCM-48B catalyst

| | Mass | | | | | | % | % | | % | % |
|---|---|---|---|---|---|---|---|---|---|---|---|
| | balance | | Tc | | WHSV | % | crack. | iso. | | crack. | C₆/C₁₀ |
| Test | (%) | T (° C.) | (min) | H2/HC | (h⁻¹) | conv. | sel. | sel. | C₈/C₁₀ | yld. | yld. |
| 1 | 98.4 | 260 | 19.94 | 4.06 | 3.01 | 96.03 | 46.78 | 53.22 | 1 | 44.93 | 38.99 |
| 2 | 98.7 | 260 | 30.64 | 3.99 | 2 | 98.67 | 76.2 | 23.8 | 1.1 | 75.18 | 52.34 |
| 3 | 99.1 | 255 | 30.64 | 4.2 | 2 | 93.98 | 36.61 | 63.39 | 0.96 | 34.40 | 29.48 |
| 4 | 99.1 | 250 | 19.94 | 4.06 | 3.01 | 73.44 | 13.07 | 86.93 | 0.94 | 9.6 | 7.8 |
| 5 | 98.7 | 250 | 31.4 | 4.09 | 1.91 | 89.36 | 24.21 | 75.79 | 1.01 | 21.63 | 20.59 |
| 6 | 99.5 | 250 | 61.33 | 4.49 | 0.98 | 95.84 | 45.23 | 54.77 | 0.97 | 43.34 | 34.24 |
| 7 | 98.7 | 240 | 20 | 4.07 | 3 | 45.92 | 4.28 | 95.72 | 0.98 | 1.96 | 1.076 |
| 8 | 97.7 | 240 | 61.02 | 4.47 | 0.98 | 71.3 | 1.1 | 88.9 | 1.01 | 7.91 | 6.32 |
| 9 | 99.2 | 230 | 20.11 | 4.09 | 2.98 | 32.68 | 2.48 | 97.52 | 0.95 | 0.81 | 0.373 |
| 10 | 98.8 | 230 | 61.33 | 4.49 | 0.98 | 41.42 | 3.75 | 96.25 | 0.97 | 1.55 | 0.866 |
| 11 | 99.2 | 220 | 20.11 | 4.09 | 2.98 | 11.67 | 1.51 | 98.49 | 1 | 0.17 | 0.032 |
| 12 | 98.3 | 220 | 61.28 | 4.49 | 0.98 | 18.2 | 2.88 | 97.12 | 1.08 | 0.52 | 0.124 |
| 13 | 99.2 | 210 | 20.11 | 4.09 | 2.98 | 5.61 | 1.57 | 98.43 | 1 | 0.88 | 0.00672 |
| 14 | 99.6 | 210 | 61.5 | 4.51 | 0.98 | 14.39 | 2.99 | 96.01 | 1 | 0.43 | 0.099 |

The Pt/MCM-48A catalyst enabled good cracking symmetry to be obtained: the C₆/C₁₀ ratio was close to 1 in most of the tests carried out, except in the case when the reaction temperature was highest (280° C.). Even for 99.8% total conversion (test 2), the cracking remained symmetrical with a C₆/C₁₀ ratio of 1.13. The best yield of the C₆-C₁₀ middle cut (middle distillates) was 61.17% (Table 6).

In the case of the Pt/MCM-48B catalyst (Table 7), in all the tests carried out, good cracking symmetry was also observed with C₆/C₁₀ ratios varying from 0.95 to 1.08. The best yield of cracking products (75.18%) and of the middle cut (52.34%) was obtained in the case of test 2.

FIGS. 3 and 4 show the distribution of the cracking products at 99.8% and 98% total conversion respectively for the Pt/MCM-48A and Pt/MCM-48B catalysts. The curves are very symmetrical (no secondary cracking) with a maximum for products centred at C₈.

The distribution of hydrocracking products for the two catalysts Pt/MCM-48A and Pt/MCM-48B, even at high conversion levels, remained symmetrical (FIGS. 3 and 4).

Activity of the Pt/MCM-48A and Pt/MCM-48B Catalysts

The activity curves for the two catalysts (total conversion as a function of the reaction temperature) coincided, these two catalysts having the same activity (FIG. 5).

The C₆/C₁₀ ratio that determines the cracking symmetry is in both cases close to 1, whatever the degree of conversion (Tables 6 and 7)—there is almost no overcracking with these two catalysts.

FIG. 6 shows the cracking products selectivity of the Pt/MCM-48A and Pt/MCM-48B catalysts. The yield is identical in the two cases. The same applies to the C₆-C₁₀ cut yield (FIG. 7).

The two synthesized catalysts behave in the same way in catalysis, the chlorination not having improved the activity of the Pt/MCM-48A catalyst.

### Example 8

### Comparison of the n-C₁₆ Hydroconversion Activities of the Pt/MCM-48A Catalyst and Zeolite-Type Catalysts

The catalyst Pt/MCM-48A was tested in the hydroconversion of nC₁₆ under the same conditions as for the Pt/HY-30 and Pt/HY-30C catalysts (the Pt/MCM-48A and Pt/MCM-48B catalysts having the same activity, as the above example shows).

Activity

FIG. 8 shows the degree of conversion as a function of the temperature for the Pt/HY30, Pt/HY-30C and Pt/MCM-48A catalysts.

It is seen that the activity of the Pt/MCM-48A catalyst is comparable with that of the Pt/HY-30C catalyst and higher than that of the Pt/HY30 catalyst.

Hydroisomerization Selectivity

FIG. 9 shows the yields of hydroisomerization and hydrocracking products as a function of total conversion for the three catalysts Pt/HY30, Pt/HY-30C and Pt/MCM-48A.

Tables 8a, 8b and 8c give the selectivity for isomers (mono, di, tri) as a function of the conversion and of the yield in hydroisomerization for the three catalysts Pt/HY30, Pt/HY 30C and Pt/MCM-48A respectively.

It is seen that the catalyst Pt/MCM-48A produces yields of hydroisomerization products that are very much greater than those obtained with the zeolite-type catalysts.

Hydrocracking Selectivity

As the results in Table 7 show, with the Pt/MCM-48A catalyst there is a symmetrical distribution of the cracking products irrespective of the total conversion or the yield of cracking products.

It has also been found that, given the same cracking products yield, the Pt/MCM-48A catalyst results in a middle distillates yield which is generally higher than that for the zeolite-type catalyst Pt/HY30C.

TABLE 8a
Hydroconversion of n-C₁₆ over Pt/HY30

| | | | Isom. | | | |
|---|---|---|---|---|---|---|
| Temperature | WHSV | Conversion | yield | Isomers selectivity | | |
| (° C.) | (h⁻¹) | (%) | (%) | Mono | Di | Tri |
| 280 | 2.8 | 99.8 | 2.2 | 33 | 47 | 20* |
| 270 | 2.8 | 68 | 42.2 | 43 | 38 | 19 |
| 260 | 3 | 48.5 | 41.6 | 50 | 35 | 15 |
| 250 | 2.8 | 43.6 | 37 | 51 | 35 | 14 |
| 240 | 3 | 16.9 | 16.1 | 65 | 28 | 7 |
| 230 | 2.8 | 8.6 | 8.4 | 72 | 24 | 4 |
| 220 | 2.9 | 4.4 | 4.3 | 76 | 21 | 3 |

TABLE 8b
Hydroconversion of n-C₁₆ over Pt/HY-30C

| | | | Isom. | | | |
|---|---|---|---|---|---|---|
| Temperature | WHSV | Conversion | yield | Isomers selectivity | | |
| (° C.) | (h⁻¹) | (%) | (%) | Mono | Di | Tri |
| 260 | 3 | 99.7 | 4 | 35 | 46 | 19* |
| 250 | 2.9 | 85.6 | 40.9 | 43 | 39 | 18 |
| 240 | 2 | 50 | 39.5 | 48 | 37 | 15 |
| 230 | 2 | 32.4 | 29 | 56 | 31 | 13 |
| 220 | 2.8 | 13.8 | 13.2 | 59 | 31 | 10 |
| 210 | 3 | 8 | 7.8 | 70 | 21 | 9 |

TABLE 8c
Hydroisomerization of n-C₁₆ over Pt/MCM-48A

| | | | Isom. | | | |
|---|---|---|---|---|---|---|
| Temperature | WHSV | Conversion | yield | Isomers selectivity | | |
| (° C.) | (h⁻¹) | (%) | (%) | Mono | Di | Tri |
| 260 | 3 | 96.03 | 51 | 35 | 44 | 21* |
| 260 | 2 | 98.7 | 22.7 | 32 | 45 | 23* |
| 250 | 3 | 73.44 | 66 | 40 | 39 | 21 |
| 250 | 2 | 89.4 | 67.7 | 38 | 41 | 21 |
| 240 | 3 | 45.9 | 44 | 56 | 33 | 11 |
| 240 | 1 | 71.3 | 63.4 | 41 | 39 | 20 |
| 230 | 3 | 32.7 | 31.9 | 61 | 30 | 9 |
| 230 | 1 | 41.2 | 39.4 | 59 | 32 | 9 |
| 220 | 3 | 11.7 | 11.5 | 76 | 21 | 3 |
| 220 | 1 | 18.2 | 17.6 | 73 | 23 | 4 |
| 210 | 3 | 5.6 | 5.5 | 81 | 17 | 2 |

*Values probably overestimated owing to the overlap between tri-branched isomers and cracking products

Catalytic Test for the Hydroconversion of Squalane (C₃₀) Over Pt/MCM-48A

The catalysts prepared were then used for the hydrocracking of squalane (2,6,10,15,19,23-hexamethyltetracosane) which is a much bulkier molecule than n-C₁₆.

The squalane hydrocracking was carried out on the same experimental set-up and under the same operating conditions as for the n-hexadecane hydrocracking (Example 7).

The liquid reaction products were analyzed by gas chromatography coupled to a mass spectrometer. The chromatography instrument used was an HP5975C fitted with a capillary column (HP5: 30 m/0.25 mm/0.25 μm). The injected volume was 1 μL. The column flow rate was adjusted to 1.2 mL/min, the injector was heated to 280° C. The temperature programme was the following: isothermal heating at 40° C. for 10 min, heating from 40° C. to 320° C. at 5° C./min, and finally isothermal heating at 320° C. for 60 min.

The detector was an FID detector at 250° C.

The mass spectrometer was used to assign the peaks.

The reaction products were also analyzed by simulated distillation (SimDist) according to the ASTM D 2887 method. This analysis provides a good indicator of the cracking behaviour of a catalyst.

Analysis of the Products

The liquid reaction products were analysed by gas chromatography coupled to a mass spectrometer, as described in Example 9. This enabled the squalane remaining in the liquid fraction to be determined, and the degrees of conversion to be calculated.

Where the chromatography peaks for the squalane isomers cover the peaks for the C₂₅-C₂₉ products, their yields were estimated by assuming that the C₁-C₅ yield corresponded to the C₂₉-C₂₅ cut and by subtracting the areas of the chromatography peaks from the areas of the chromatography peaks for the isomers.

The distribution of the cracking products was examined for the following product ranges: C₁-C₅, C₆-C₁₀, C₁₁-C₁₅, C₁₆-C₁₉, C₂₀-C₂₄ and C₂₅-C₂₉.

The results obtained for the gas phase (C₁-C₈ products) and the liquid phase were added.

In order to compare the distributions in terms of cracking products and the simulated distillation profiles for equivalent cracking yields for the catalysts, the results were interpolated each time within the interval of two apparent cracking yields.

For example, the percentage by weight of C₁-C₅ products at 25% conversion was calculated according to the following formula, with a 25% cracking yield, between the yields X1 and X2:

wt % X25=wt % X1+((25−X1)*(wt % X2−wt % X1)/(X2−X1)),

where wt % represents the percentage by weight to be calculated.

### Example 9

### Catalytic Test for the Hydroconversion of Squalane (Hexamethyltetracosane) Over Pt/MCM-48A

FIG. 10 shows the distribution of the squalane cracking products at 99% total conversion (left-hand columns) and 75% total conversion (right-hand columns) for the Pt/MCM-48A catalyst. The results obtained confirm the capability of this catalyst to produce middle distillates.

### Example 10

### Comparison of the Squalane (Hexamethyltetracosane) Hydroconversion Activities of the Pt/MCM-48A Catalyst and of Zeolite-Type Catalysts

To compare the performance of the Pt/MCM-48A catalyst, two zeolite catalysts were used (Example 6) for comparison:
the catalyst Pt/HY30
the catalyst Pt/HY30C.

As FIG. 11 shows, the activity of the Pt/MCM-48A catalyst is lower than that of the zeolite catalysts.

The proportion of heavier products in the cracking products obtained with the Pt/MCM-48A catalyst is higher than that obtained for the other catalysts, as the distribution of the cracking products in FIG. 11 shows. A lower tendency to overcracking of the first products formed is observed in the case of the Pt/MCM-48A catalyst. These results are all the more significant for high degrees of conversion (FIG. 11).

Comparison of the Simulated Distillation Curves for the Pt/MCM-48A, Pt/HY30 and Pt/HY30C Catalysts

FIG. 12 shows the simulated distillation curves for the liquid phase products obtained for various cracking yields.

The curves in FIG. 12 show a markedly lower tendency to form light products in the case of the Pt/MCM-48A catalyst, this being particularly noticeable for total conversion.

The distribution of the percent mass contents in various temperature ranges, as given in Table 8, shows that the heaviest products with high boiling points are more abundant for the Pt/MCM-48A catalyst, thereby confirming that overcracking is markedly less for this catalyst.

Conclusion

The hydrocracking of squalane shows that the Pt/MCM-48A catalyst exhibits better middle distillates selectivity and a lower overcracking tendency compared with zeolite catalysts. The Pt/MCM-48A catalyst with a pore diameter of 3.8 nm exhibits virtually ideal symmetry for maximum yields of middle distillates.

TABLE 9
Distribution of the percent mass contents of the recovered products for
various cracking yields for the Pt/HY30, Pt/HY30C and Pt/MCM-48A catalysts

| | % mass content of the products recovered for various | | | | | | | | | | | |
|---|---|---|---|---|---|---|---|---|---|---|---|---|
| | cracking yields | | | | | | | | | | | |
| | 25% yield | | | 50% yield | | | 75% yield | | | 99% yield | | |
| T | Cat | | | | | | | | | | | |
| (° C.) | (1) | (2) | (3) | (1) | (2) | (3) | (1) | (2) | (3) | (1) | (2) | (3) |
| <65 | 1.3 | 1.0 | 1.2 | 3.3 | 2.7 | 3.2 | 8.4 | 4.4 | 4.7 | 31.3 | 22.1 | 6.1 |
| 65-145 | 3.3 | 2.7 | 2.8 | 5.4 | 7.4 | 5.9 | 16.9 | 12.1 | 12.4 | 43.5 | 35.3 | 19.4 |
| 145-250 | 6.4 | 6.3 | 5.7 | 14.2 | 15.2 | 11.2 | 24.0 | 24.0 | 22.4 | 24.7 | 35.2 | 34.6 |
| 250-375 | 10.1 | 12.1 | 11.3 | 17.2 | 19.6 | 20.6 | 18.2 | 27.2 | 26.2 | 0.5 | 4.4 | 30.6 |
| 375-249 | 78.9 | 77.9 | 79.0 | 56.4 | 55.1 | 59.1 | 32.5 | 32.3 | 34.3 | 0.0 | 0.0 | 9.3 |

Cat (1): Pt/HY30 catalyst;
Cat (2): Pt/HY30C catalyst;
Cat (3): Pt/MCM-48A catalyst.

1. Method for preparing a hydroconversion catalyst based on mesoporous silica or silica-alumina, comprising the following steps:
(A) deposition of alumina on a mesoporous material having interconnected pores by treatment with at least one aluminium-based reactant, so as to obtain a compound having a Si/Al ratio of between 0.1 and 1000;
(B) addition of at least one catalytically active species chosen from the group formed by the metals of group VIII and/or of group VIB; and
(C) drying followed by thermal and/or chemical treatment,

2. Method of preparation according to claim 1, in which the aluminium-based reactant of step (A) is chosen from AlCl₃, NaAlO₄, Al(NO₃)₃ and Al(OR)₃ where R is chosen from linear or branched C₁-C₆ alkyl groups.

3. Method of preparation according to claim 1, in which step (B) further includes the addition of one or more dopant metals chosen from the group of rare earths or from group IVB or IB and/or the addition of one or more other dopant elements for example chosen from chlorine, fluorine, boron and phosphorus.

4. Method of preparation according to claim 3, in which the one or more dopant metals are Ti and/or Cu.

5. Method of preparation according to claim 1, in which step (A) is a step of grafting Al(OR)₂ groups onto a silica or silica-alumina having interconnected mesoporosity, in which R is chosen from linear or branched C₁-C₆ alkyl groups.

6. Method of preparation according to claim 5, in which step (A) of grafting Al(OR)₂ groups comprises:
(i) reaction of the mesostructured silica or silica-alumina, with an aluminium-containing compound of formula Al(OR)₃ in which R is chosen from linear or branched C₁-C₆ alkyl groups, in the presence of an activation agent for activating the protons of the silanol groups of the silica in a solvent, the water content of which is less than or equal to 0.005% by weight, preferably less than or equal to 0.0002% by weight;
(ii) separation of the solid by filtration, optionally followed by washing of the solid at least once with the same solvent as that used in the preceding step;
(iii) hydrolysis of the Al(OR) groups grafted onto the silica by mixing the washed solid in a solution containing at least one alcohol of formula R₁OH, R₁ being chosen from linear or branched C₁-C₆ alkyl groups, and a stoichiometric quantity of water;
(iv) filtration and washing of the solid obtained in an alcohol followed by drying; and
(v) calcination of the washed and dried product.

7. Method of preparation according to claim 6, in which the solvent of step (i) is an apolar solvent.

8. Method of preparation according to claim 7, in which the apolar solvent is chosen from benzene, toluene, xylene, cyclohexane, n-hexane, pentane, cumene, by themselves or as a mixture, preferably toluene.

9. Method of preparation according to claim 6, in which the aluminium-containing compound of step (i) is aluminium tri-sec-butoxide, Al(O-sec-Bu)₃.

10. Method of preparation according to claim 6, in which the agent for activating the silanol groups of the silica is chosen from organic basic compounds, for example amines, preferably triethylamine, and nitriles.

11. Method of preparation according to claim 6, in which the hydrolysis step (iii) is carried out at room temperature for a time of 0.1 to 48 hours, preferably 1 to 36 hours.

12. Method of preparation according to claim 1, in which step (A) of depositing alumina is repeated several times, preferably 2 to 10 times.

13. Method according to claim 1, in which steps (A) and (B) are carried out simultaneously.

14. Method according to claim 1, in which step (A) of depositing alumina on a material based on silica or silica-alumina of interconnected mesoporous texture is followed by a step of forming the alumina-treated material based on silica or silica-alumina of interconnected mesoporous texture, whether this material is pure or combined with at least one binder.

15. Method according to claim 1, in which a step of forming the material based on silica or silica-alumina of interconnected mesoporous texture, whether pure or combined with at least one binder, is carried out before step (A) of depositing alumina.

16. Method according to claim 1, which further includes a step (D) of activating the catalyst, comprising a sulphurization step generally followed by a reduction step using hydrogen.

17. Hydroconversion catalyst obtained by the method according to claim 1, comprising a mesoporous material having interconnected pores, said material being coated with alumina and having a Si/Al ratio of between 0.1 and 1000, and at least one catalytically active species chosen from the metals of group VIII and/or of group VIB.

18. Hydroconversion catalyst according to claim 17, comprising the mesoporous material composed of mesoporous MCM-48 silica, preferably presenting a cubic structure, said material being coated with alumina and having a Si/Al ratio of between 0.1 and 1000, and at least one catalytically active species chosen from the metals of group VIII and/or of group VIB.

19. Method of hydroconverting a hydrocarbon feedstock, which comprises bringing the feedstock to be treated into contact with a hydroconversion catalyst according to claim 17.

20. Hydroconversion method according to claim 19, in which the hydrocarbon feedstock is chosen from residues, hydrocracking distillates, raffinates, atmospheric gas oils, vacuum gas oils, coking oils, vacuum or atmospheric distillation residues, deasphalted oils, residual waxes and Fischer-Tropsch waxes.
